(19) United States
(12) Patent Application Publication
(10) Pub. No.: US 2025/0003729 A1
(43) Pub. Date: Jan. 2, 2025

(54) STRAIN DETECTION DEVICE

(71) Applicant: JAPAN DISPLAY INC., Tokyo (JP)

(72) Inventors: Toshinori UEHARA, Tokyo (JP); Fumihoru NAKANO, Tokyo (JP)

(21) Appl. No.: 18/738,156

(22) Filed: Jun. 10, 2024

(30) Foreign Application Priority Data
Jun. 29, 2023 (JP) 2023-106939

(51) Int. Cl. G01B 7/16

(52) U.S. Cl. CPC G01B 7/18

(57) ABSTRACT

According to one embodiment, a strain detection device includes a sheet base material, a plurality of strain gauges arranged in a first direction on the sheet base material, a plurality of power supply lines and a plurality of first signal lines each connected to one end of a respective one of the plurality of strain gauges, and a plurality of ground lines and a plurality of second signal lines each connected to an other end of a respective one of the plurality of strain gauges, and a dummy pattern provided on the sheet base material and located between two of the plurality of strain gauges adjacent to each other in the first direction.

### CROSS-REFERENCE TO RELATED APPLICATIONS

This application is based upon and claims the benefit of priority from Japanese Patent Application No. 2023-106939, filed Jun. 29, 2023, the entire contents of which are incorporated herein by reference.

### FIELD

Embodiments described herein relate generally to a strain detection device.

### BACKGROUND

As an example of the strain detection device, a film-like or sheet-like strain gauge sensor is known. Such a strain gauge sensor includes a plurality of strain gauges provided side by side on a surface of a strip-shaped flexible sheet substrate and a plurality of signal lines for supplying current to these strain gauges. By wrapping the strain gauge sensor around a curved sample object and detecting the change in resistance of each strain gauge, the curved shape of the sample object can be detected.

In the strain gage sensor, a plurality of strain gages are provided to be arranged side by side at intervals. With this configuration, the elastic modulus of the sheet base varies from a portion where strain gauges are present to a portion without strain gauges, and the portion with high elastic modulus does not easily bend, whereas the portion with low elastic modulus easily bend. Therefore, when strain gage sensors are disposed while being bent, stress may be concentrated on the portion without strain gages, resulting in non-uniformity of shape. In this case, it is difficult detect strain at high accuracy.

### BRIEF DESCRIPTION OF THE DRAWINGS

FIG. 1 is a perspective view showing a strain gauge sensor device according to the first embodiment.

FIG. 2 is a plan view showing a part of a sensor sheet of the strain gauge sensor device.

FIG. 3 a block diagram showing the sensor sheet and a controller of the strain gauge sensor device.

FIG. 4 is a side view of the sensor sheet when it is bent.

FIG. 5A is a plan view showing a part of a sensor sheet according to a first modified example.

FIG. 5B is a plan view showing a part of a sensor sheet according to a second modified example.

FIG. 6 is a plan view showing a part of a sensor sheet according to a third modified example.

FIG. 7 is a plan view showing a part of a sensor sheet of a strain gauge sensor device according to the second embodiment.

FIG. 8 is a plan view showing a part of a sensor sheet of a strain gauge sensor device according to the third embodiment.

FIG. 9 is a perspective view showing a strain gauge sensor device according to the fourth embodiment.

FIG. 10 is a cross sectional view showing a strain gauge sensor device according to the fourth embodiment.

FIG. 11 is an exploded perspective view showing a part of a sensor sheet and a base substrate of the strain gauge sensor device according to the fourth embodiment.

### DETAILED DESCRIPTION

Various embodiments will be described hereinafter with reference to the accompanying drawings. In general, according to one embodiment, a strain detection device includes a sheet base material, a plurality of strain gauges arranged in a first direction on the sheet base material, a plurality of power supply lines and a plurality of first signal lines each connected to one end of a respective one of the plurality of strain gauges, and a plurality of ground lines and a plurality of second signal lines each connected to an other end of a respective one of the plurality of strain gauges, and a dummy pattern provided on the sheet base material and located in an area between a respective pair of strain gauges adjacent to each other in the first direction.

Note that the disclosure is merely an example, and proper changes in keeping with the spirit of the invention, which are easily conceivable by a person of ordinary skill in the art, come within the scope of the invention as a matter of course. In addition, in some cases, in order to make the description clearer, the drawings show schematic illustration rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

### First Embodiment

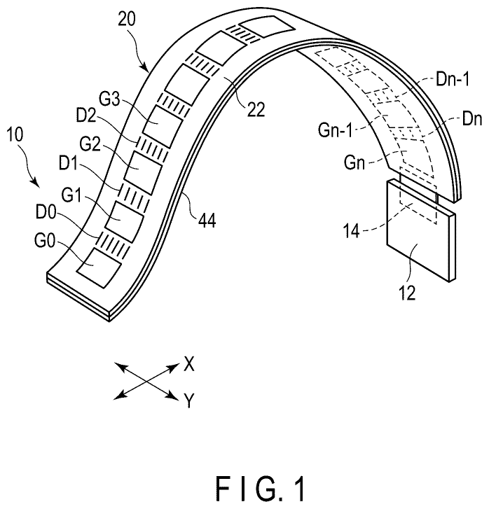

As an example of the strain detection devices, a strain gauge sensor device according to an embodiment will be described in detail. FIG. 1 is a perspective view of the strain gauge sensor device of the first embodiment.

As shown in the figure, according to the first embodiment, the strain gauge sensor device 10 is configured as a single-sided strain gauge sensor. The strain gauge sensor device 10 comprises an elongated strip-shaped flexible base substrate 44 that functions as a base material, a sensor sheet 20 attached on one surface of the base substrate 44, and a relay substrate (drive circuit board) 12 connected to the sensor sheet 20 via a flexible circuit board (FPC) 14. In one example, the base substrate 44 is formed of a resin such as polyethylene terephthalate (PET), polyimide, or the like, to have a thickness of about 0.3 to 0.5 mm.

In the figure, the longitudinal direction X and the width direction Y of the base substrate 44 and the sensor sheet 20 are two directions orthogonal to each other. These directions may intersect at an angle other than 90 degrees.

The sensor sheet 20 includes an elongated strip-shaped flexible sheet base material 22 and a conductor pattern provided on one surface side of the sheet base material 22. The conductor pattern includes a plurality of strain gauges G0 to Gn and a plurality of signal lines and power lines, which will be described later. The plurality of strain gages G0 to Gn are provided to be arranged in a row in the longitudinal direction X at a predetermined interval therebetween from one end to the other end of the sheet base material 22 in the longitudinal direction X. The sensor sheet 20 with a surface where the conductor patterns (G0 to Gn) are provided, is attached to the front surface of the base substrate 44 by an adhesive layer such as a transparent adhesive sheet (OCA). Alternatively, the sensor sheet 20 may as well be configured to be attached, by its sheet substrate 22 side, to the front surface of the base substrate 44 by the adhesive layer.

The relay substrate 12 includes a drive circuit 40, which will be described later, and a plurality of wiring lines. The conductor pattern of the sensor sheet 20 is connected to the wiring lines of the relay substrate 12 via the FPC 14.

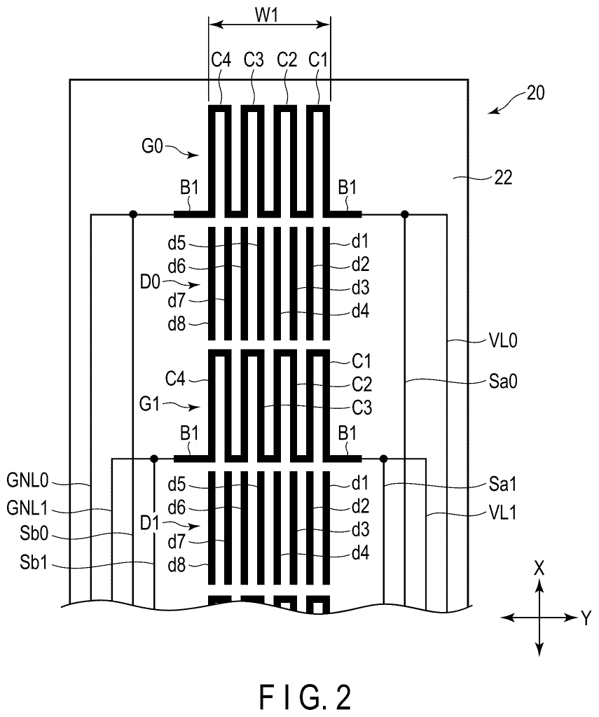

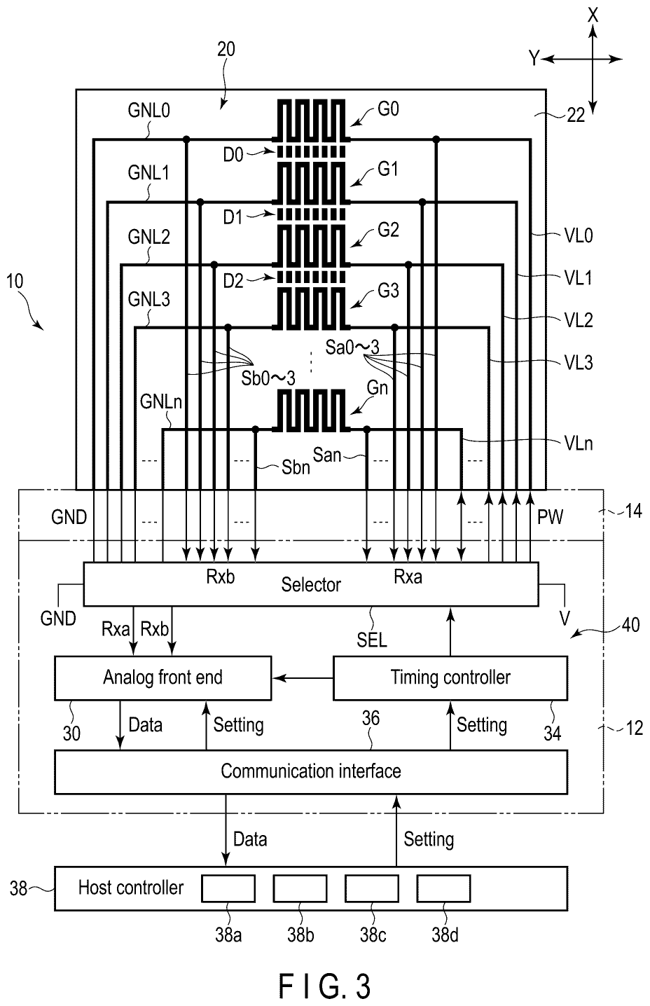

FIG. 2 is a plan view showing a part of the sensor sheet 20, and FIG. 3 is a schematic view showing strain gages and wiring patterns of the sensor sheet 20 and a controller of the strain gage sensor device 10.

As shown in the figures, according to the present embodiment, the sensor sheet 20 includes a flexible strip-shaped sheet base material 22 and a conductor pattern provided on one surface side of the sheet base material 22. The conductor pattern is a wiring pattern formed of a conductive metal such as aluminum, titanium, or copper, and includes a plurality of strain gauges G0 to Gn, a plurality of dummy patterns DO to Dn, and a plurality of wiring lines. For example, each wiring pattern is formed to have a constant width.

As shown in FIG. 2, the plurality of strain gages G0 to Gn are provided to be arranged in a row so as to be spaced apart from each other in the longitudinal direction X from one end (distal end) to the other end (proximal end) of the sheet base material 22. Each of the strain gages G0 to Gn extends in bellows manner in the width direction Y and includes one end and the other end in its width direction Y. According to this embodiment, each of the strain gages G0 to Gn comprises a base line B1 extending in the width direction Y and including one end and the other end in the width direction Y, and a plurality of, for example, four waveform lines C1 to C4, extending from the base line B1 in one direction in the longitudinal direction X. For example, the four waveform lines C1 to C4 are each formed into a rectangular waveform shape, which has a common height in the longitudinal direction X. The four waveform lines C1 to C4 are arranged to be spaced apart from each other in the width direction Y. The four waveform lines C to C4 are located within a width W1 in the width direction Y. Each of the strain gages G0 to Gn produces a change in resistance according to its strain.

A plurality of dummy patterns DO to Dn are each provided in an area between each respective pair of strain gauges adjacent to each other in the longitudinal direction X. For example, each of the dummy patterns DO to Dn includes a plurality of, for example, eight dummy lines d1 to d8 formed straight. The eight dummy lines d1 to d8 each extend in the longitudinal direction X and are arranged to be spaced apart from each other in the width direction Y. The eight dummy lines d1 to d8 are located within the width W1 and each aligned with the waveform lines C1 to C4 of the strain gages in the longitudinal direction X. Each of the dummy lines d1 to d8 includes one end in its longitudinal direction X located near one strain gage and the other end in its longitudinal direction X located near the other strain gage.

As described above, with the dummy patterns D0 to Dn thus provided in the area between two adjacent strain gauges, the modulus of elasticity of the area where strain gauges G0 to Gn are provided and that of the gap area where no strain gauge is provided can be made substantially equal to each other in the sensor sheet 20.

As shown in FIGS. 2 and 3, the conductor patterns include a plurality of power lines VL0 to VLn, a plurality of ground lines GNL0 to GNLn, a plurality of first signal lines Sa0 to San, and a plurality of second signal lines Sb0 to Sbn, extending in the longitudinal direction X along rows of the strain gauges G0 to Gn, respectively.

The power supply lines VL0 to VLn are located on one end side of the strain gauges G0 to Gn. The power supply lines VL0 to VLn include respective one ends connected to, on the one end side, the strain gauges G0 to Gn and the other ends located on the proximal end side of the sheet base material 22, and they extend approximately parallel to each other.

The first signal lines Sa0 to San are located between one end side of the strain gauges G0 to Gn and the power supply lines VL0 to VLn. The first signal lines Sa0 to San include respective one ends connected to the strain gauges G0 to Gn and the other ends located on the proximal end side of the sheet base material 22, and they extend approximately parallel to each other.

The ground lines GNL0 to GNLn are located on the other end side of the strain gauges G0 to Gn. The ground lines GNL0 to GNLn include respective one ends connected to the other ends of the strain gauges G0 to Gn and the other ends located on the proximal end side of the sheet base material 22, and they extend approximately parallel to each other.

The second signal lines Sb0 to Sbn are located between the other ends of the strain gauges G0 to Gn and the ground lines GNL0 to GNLn. The second signal lines Sb0 to Sbn include respective one ends connected to the other ends of the strain gauges G0 to Gn and the other ends located on an proximal end of the sheet base material 22, and they extend approximately parallel to each other.

The power supply lines VL0 to VLn, the first signal lines Sa0 to San, the second signal lines Sb0 to Sbn, and the ground lines GNL0 to GNLn are to be connected to the drive circuit 40 on the relay substrate 12.

Note here that the metal layer in which the strain gages G0 to Gn, the dummy patterns D0 to Dn, the power supply lines VL0 to VLn, and the ground lines GNL0 to GNLn are formed on the sensor sheet 20 is made in a separate layer from the metal layer in which the first signal lines Sa0 to San and the second signal lines Sb0 to Sbn are formed. An insulating intermediate layer is provided between these two metal layers, and the first signal lines Sa0 to San and the second signal lines Sb0 to Sbn are connected to the power supply lines VL0 to VLn and the ground lines GNL0 to GNLn via through holes formed in the intermediate layer. Note that either or both of the strain gages G0 to Gn and the dummy patterns D0 to Dn may as well be formed from a metal layer different from the metal layer in which the power supply lines VL0 to VLn and the ground lines GNL0 to GNLn are formed.

Next, the driving circuit (controller) that drives the sensor sheet 20 configured as described above will be described.

As shown in FIG. 3, the drive circuit 40 provided on the relay substrate (control circuit board) 12 includes a selector SEL, an analog front end (AFE: signal adjusting circuit) 30, a timing controller 34, a communication interface 36, and the like.

The communication interface 36 is wirelessly or by wire connected to an external host controller 38, so as to receive drive signals (setting) from the host controller 38 and transmit detection data (Data) to the host controller 38.

The timing controller 34 outputs drive signals to the selector SEL and the analog front end 30 according to the drive signal (setting).

The selector SEL is constituted by a plurality of shift registers, multiplexers, and the like. The selector SEL sequentially connects the power supply lines VL0 to VLn of the sensor sheet 20 to the power supply and applies voltages sequentially to the strain gages G0 to Gn according to the drive signals from the timing controller 34. In synchronization with this, the selector SEL sequentially reads detection signals (voltage values) RXa0 to RXan and RXb0 to RXbn at one end side and the other end side of the strain gages G0 to Gn via the first signal lines Sa0 to San and the second signal lines Sb0 to Sbn.

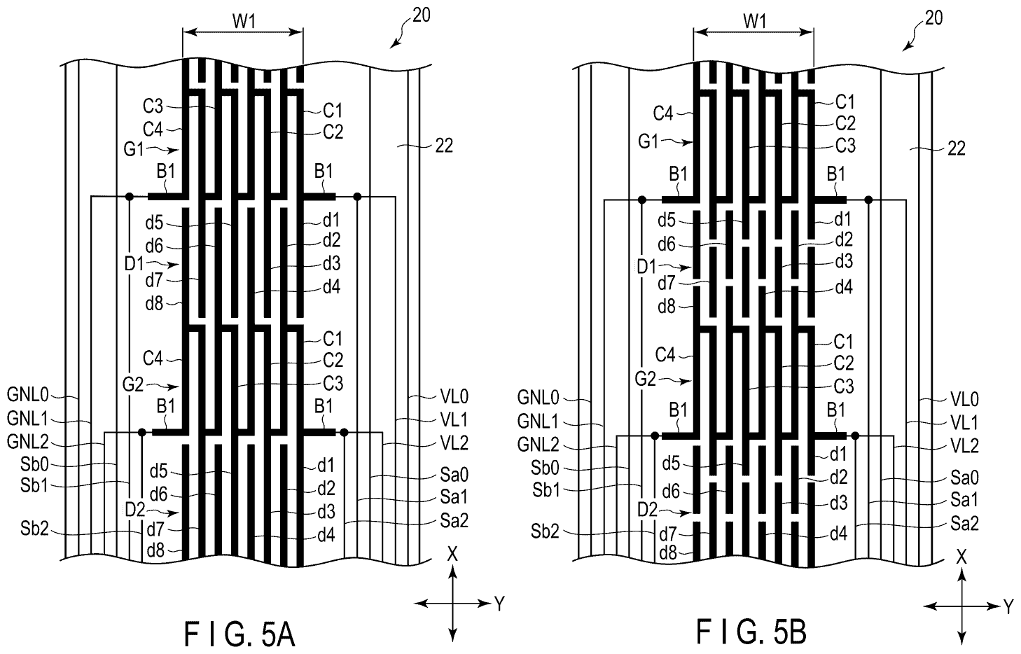

As shown in FIG. 5, the analog front end 30 includes a readout circuit, a differential detection circuit, an AD converter, a digital filter, a memory, and the like, which are not shown in the figure. The analog front end 30 adjusts signals (amplification, AD conversion and filtering) such as the detection signals RXa and RXb and detection signals RXc and RXd of each of the strain gauges G0 to Gn sent from the selector SEL according to the drive signal, and outputs them to the communication interface 36. At this time, since the voltage drop value of each strain gage G is required to calculate the radius of curvature, the difference between the detected values Rxa and Rxb of each of the strain gages G0 to Gn and the difference between the detected values Rxc and Rxd of each of the strain gages G0 to Gn are taken by the difference detection circuit and output as signals.

The host controller 38 includes a readout circuit 38a, a memory 38b, an arithmetic processing unit 38c and the like. The readout circuit 38a reads the output signal (differential data) sent from the communication interface 36 and stores it in the memory 38b. The arithmetic processing unit 38c, for example, CPU, performs data forming, surface calculation and other arithmetic operations based on the differential data to calculate out the strain (radius of curvature), surface form (surface coordinates) and the like of the sample detected by the sensor sheet 20. The differential data, the radius of curvature thus calculated, the curved surface form, the detection operation program and the like are stored in the memory 38b.

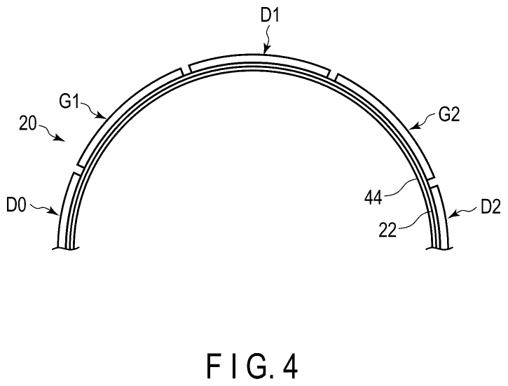

FIG. 4 is a side view of the sensor sheet 20 of the strain gauge sensor device 10 configured as described above in a curved state.

According to the sensor sheet 20 having the above-described configuration, dummy patterns D0 to Dn are provided in the respective area between each respective pair of strain gauges adjacent to each other in the longitudinal direction X. Thus, the modulus of elasticity of the area where the strain gauges G0 to Gn are provided and the modulus of elasticity of the gap area where the strain gauges are not provided can be made substantially equal to each other. That is, the elastic modulus of each of the regions in the longitudinal direction X of the sensor sheet 20 can be made uniform. Therefore, as shown in FIG. 4, when the sensor sheet 20 is curved, the entire longitudinal area can be curved evenly without concentrating stress in a part of the sensor sheet 20. That is, the area where the strain gauges G0 to Gn are provided can be curved evenly.

Therefore, for example, when the sensor sheet 20 is wrapped around the outer circumferential surface of a sample and placed to detect strain on the outer circumferential surface, detect the radius of curvature, and the like, each of the strain gages G0 to Gn can be curved along the outer circumferential surface and tightly attached to the outer circumferential surface. With this configuration, it is possible to accurately detect the distortion of the outer circumferential surface by each of the strain gages and to improve the detection accuracy.

From the above-provided descriptions, according to this embodiment, it is possible to obtain a strain gage sensor device with improved detection accuracy.

Note that in the first embodiment described above, the dummy pattern D of the sensor sheet 20 is not limited to that of the embodiment, but can be changed in various ways. In the following, modified examples of the dummy pattern D will be described. In the modified examples provide below, the same parts as those in the first embodiment described above are denoted by the respective same reference symbols as those of the first embodiment, and the detailed descriptions thereof may be simplified or omitted.

### First Modified Example

FIG. 5A is a plan view showing a part of the sensor sheet according to the first modified example. As shown in the figure, according to the first modified example, each of the dummy patterns D0 to Dn includes a plurality of, for example, eight dummy lines d1 to d8 formed in a straight line. The eight dummy lines d1 to d8 each extend in the longitudinal direction X and are arranged to be spaced apart from each other in the width direction Y. The eight dummy lines d1 to d8 are arranged within the width W1 and are arranged with the waveform lines C1 to C4 of the strain gage, respectively, in the longitudinal direction X.

In the first modified example, of the eight dummy lines d1 to d8, a plurality of, for example, four dummy lines (first lines) are connected by one end side to the waveform lines of one of the two adjacent strain gauges. The other four dummy lines are, by one end side, connected to the waveform lines of the other strain gauge. For example, dummy lines (first lines) d1, d3, d5, and d7 are connected to the waveform lines C1, C2, C3, and C4 of one strain gage G1, and dummy lines (second lines) d2, d4, d6, and d8 are connected to the waveform lines C1, C2, C3, and C4 of the other strain gage G2. With this structure, the dummy lines d1 to d8 are arranged side by side in a so-called nested arrangement.

In the first modified example, the other structures of the sensor sheet 20 are similar to those of the sensor sheet 20 of the first embodiment described above.

In the sensor sheet 20 according to the first modified example, advantageous effects similar to those of the aforementioned first embodiment can be obtained. Further, in the first modified example, a plurality of dummy lines are disposed in the gap areas between the dummy patterns D0 to Dn and the strain gauges G0 to Gn, the elastic modulus of each gap area can be increased. In this manner, it is possible to further uniform the elastic moduli of the gap areas of the sensor sheet 20.

### Second Modified Example

FIG. 5B is a plan view showing a part of the sensor sheet according to the second modified example. As shown in the figure, according to the second modified example, each of the dummy patterns D0 to Dn includes a plurality of dummy lines, for example, eight dummy lines d1 to d8, arranged in a manner similar to that of the first modified example described above. Further, in the second modified example, each of the dummy lines d1 to d8 is divided at one point in the longitudinal direction X and divided into two lines. The divided portions of the dummy lines d1 to d8 are located to be displaced from each other in the longitudinal direction X so as not to be aligned in the width direction Y.

In the second modified example, the other structures of the sensor sheet 20 are similar to those of the sensor sheet 20 in the first modified example described above.

In the sensor sheet 20 of the second modified example as well, advantageous effects similar to those of the first modified example described above can be obtained. Further, in the second modified example, the parasitic capacitance can be reduced by dividing the dummy lines. Note that the number of dummy lines divided is not limited to two, but can be three or more.

### Third Modified Example

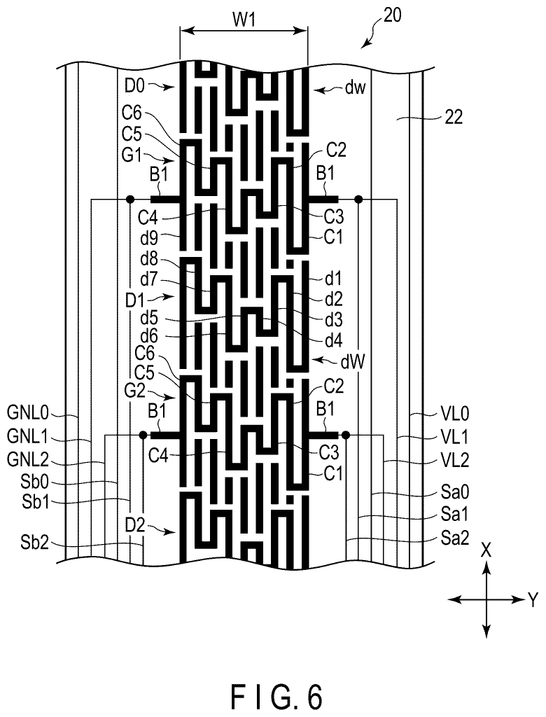

FIG. 6 is a plan view showing a part of the sensor sheet according to the third modified example. As shown in the figure, according to the third modified example, each of the strain gages G0 to Gn and each of the dummy patterns D0 to Dn are formed in a random pattern. In detail, each of the strain gages G0 to Gn includes a base line B1 extending in the width direction Y, a plurality of waveform lines C1, C3, and C4 each extending from the base line B1 in one direction of the longitudinal direction X, and a plurality of waveform lines C2, C5, and C6 each extending from the base line B1 in a direction opposite to the longitudinal direction X. For example, the waveform lines C1, C3, and C4 have a rectangular waveform shape and are formed at extension heights different from each other with reference to the base line B1. The waveform lines C2, C5, and C6 have a rectangular waveform shape and are formed at extension heights different from each other with reference to the base line B1.

Each of the dummy patterns D0 to Dn includes a plurality of, for example, nine dummy lines d1 to d9 formed into straight lines. The nine dummy lines d1 to d9 each extend in the longitudinal direction X and are arranged to be spaced apart from each other in the width direction Y. The nine dummy lines d1 to d9 are aligned with the waveform lines C1 to C6 of the strain gages, respectively, in the longitudinal direction X.

Of the nine dummy lines d1 to d9, a plurality of, for example, the dummy lines d1 and d9 located on both end sides in the width direction Y, are connected by their one end side in the longitudinal direction X to the waveform lines of the strain gage G1 or G2, and the other ends in the longitudinal direction X are located to oppose each other with a slight gap between the waveform lines of the strain gage G1 or G2. As to each of the other seven dummy lines d2 to d8, one end in the longitudinal direction X opposes the waveform line of the strain gage G1 with a slight gap therebetween, and the other end in the longitudinal direction X opposes the waveform line of the strain gage G2 with a slight gap therebetween.

The gaps between one-side ends of the nine dummy lines d1 to d9 and the strain gage G1 are displaced from each other in the longitudinal direction X without being aligned in the width direction Y. Similarly, the gaps between the ends of the other side of the nine dummy lines d1 to d9 and the strain gage G2 are displaced from each other in the longitudinal direction X without being aligned in the width direction Y.

Each of the nine dummy lines d1 to d9 is divided at a middle portion in the longitudinal direction X into two or three lines. The divided segments of the dummy lines d1 to d9 are displaced from each other in the longitudinal direction X without being aligned in the width direction Y.

Further, of the divided lines of the nine dummy lines d1 to d9, in the divided lines located in the middle portion in the longitudinal direction X, the end portions of each respective pair of dividing lines adjacent to each other in the width direction Y are connected to each other by a connecting line extending in the width direction Y, so as to form a wavy dummy line dw that extends continuously in a wave-like shape.

In the third modified example, the other structures of the sensor sheet 20 are similar to those of the sensor sheet 20 of the first embodiment described above. In the sensor sheet 20 according to the third modified example, advantageous effects similar to those of the aforementioned first and second modified examples can be obtained. Furthermore, in the third modified example, the strain gages and the dummy lines are disposed in a more random manner, the elastic modulus of the sensor sheet 20 can be made more uniform.

Next, a strain gage sensor device according to other embodiments of this invention will be described. In the other embodiments described below, parts identical to those of the aforementioned first embodiment are denoted by the same reference symbols as those of the first embodiment, and detailed descriptions thereof may be simplified or omitted.

### Second Embodiment

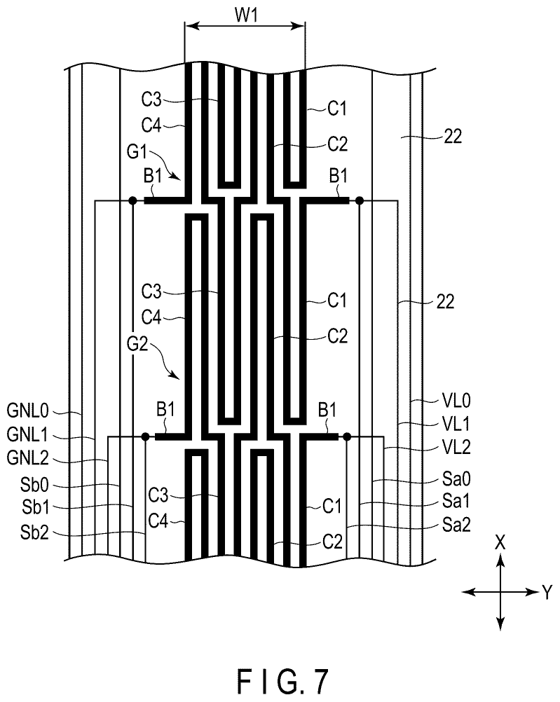

FIG. 7 is a plan view of a part of a sensor sheet in a strain gage sensor device according to the second embodiment. In the second embodiment, dummy lines are omitted, and in place, the area between adjacent strain gages is filled with wave lines by arranging the wave lines of adjacent strain gages in a nested arrangement.

In detail, as shown in FIG. 7, the strain gages G0 to Gn are arranged side by side in the longitudinal direction X of the sensor sheet 20. Each of the strain gages G0 to Gn includes a base line B1 extending in the width direction Y, a plurality of, for example, two waveform lines (first waveform lines) C1 and C3 each extending from the base line B1 in one direction of the longitudinal direction X, and a plurality of, for example, two waveform lines (second waveform lines) C2 and C4 each extending from the base line B1 in the opposite direction of the longitudinal direction X. For example, the waveform lines C1 to C4 each have a rectangular waveform shape.

The waveform lines C1 and C3 are located at an interval of a distance equivalent to one waveform line in the width direction Y. The waveform lines C1 and C3 extend in the longitudinal direction X from the base line B1 of the strain gage G1 to the vicinity of the base line B1 of the next strain gage G2.

The waveform lines C2 and C4 are located at an interval of a distance equivalent to one waveform line in the width direction Y. The waveform lines C2 and C4 extend in the longitudinal direction X from the base line B1 of one strain gage G2 to the vicinity of the base line B1 of the next strain gage G1 and are arranged to be in a nested manner with respect to the waveform lines C1 and C3 of the next strain gage G1. That is, the waveform lines C1 and C3 of one strain gage and the waveform lines C2 and C4 of the other strain gage are arranged side by side in the width direction Y and provided in the region between adjacent strain gages, that is, in this case, the area between the base line B1 of one strain gage and the base line B1 of the other strain gage.

As described above, according to the second embodiment, the strain gauges G0 to Gn are provided over the entire sheet base material 22 in the longitudinal direction X. Therefore, the elastic modulus of the sensor sheet 20 can be made uniform in substantially the entire sensor sheet 20 in the longitudinal direction X.

In the second embodiment, the other structures of the strain gage sensor device are similar to those of the strain gage sensor device in the first embodiment described above. In the second embodiment as well, it is possible to obtain a strain gage sensor device with improved detection accuracy.

### Third Embodiment

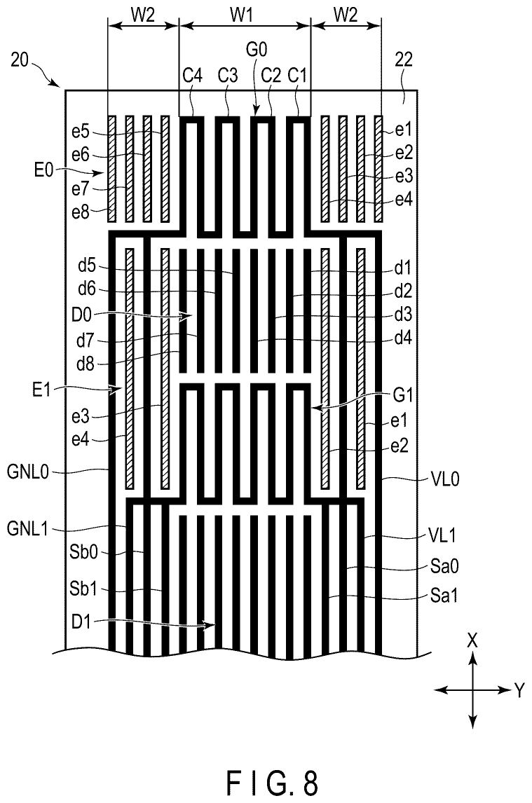

FIG. 8 is a plan view showing a part of a sensor sheet in a strain gage sensor device according to the third embodiment. In the third embodiment, the sensor sheet 20 of the strain gauge sensor device includes dummy wiring patterns E0 to En in addition to the dummy patterns D0 to Dn. The dummy wiring patterns E0 to En are provided to overlap an area of the sensor sheet 20 where the strain gages G0 to Gn, the power supply lines, the ground lines, and the signal lines are not provided.

In detail, as shown in FIG. 8, the sensor sheet 20 includes a sheet base material 22 and a conductor pattern formed on one surface of the sheet base material. The conductor pattern is a wiring pattern of a fixed width, that is formed of a conductive metal such as aluminum, titanium, copper, or the like, and includes a plurality of strain gauges G0 to Gn, a plurality of dummy patterns D0 to Dn, a plurality of wiring lines, and a plurality of dummy wiring patterns E0 to En.

The plurality of strain gauges G0 to Gn are provided in a row so as to be spaced apart from each other in the longitudinal direction X from one end (distal end) to the other end (proximal end) of the sheet base material 22 in the longitudinal direction X. Each of the strain gages G0 to Gn includes a base line B1 extending in the width direction Y and including one end and the other end in the width direction Y, and a plurality, for example, four waveform lines C1 to C4, extending from the base line B1 in one direction of the longitudinal direction X. The four waveform lines C1 to C4 are arranged to be spaced apart from each other in the width direction Y. The four waveform lines C1-C4 are located within a width W1 in the width direction Y.

The plurality of dummy patterns D0 to Dn are each provided in an area between a respective pair of strain gauges adjacent to each other in the longitudinal direction X. For example, each of the dummy patterns D0 to Dn includes a plurality of, for example, eight dummy lines d1 to d8 formed straight. The eight dummy lines d1 to d8 each extend in the longitudinal direction X and are arranged to be spaced apart from each other in the width direction Y. The eight dummy lines d1 to d8 are located within the width W1 and are aligned with the waveform lines C1 to C4 of the strain gages, respectively, in the longitudinal direction X. Each of the dummy lines d1 to d8 includes one end in its longitudinal direction X, located near one strain gage and the other end in its longitudinal direction X, located near the other strain gage.

The plurality of wiring lines include a plurality of power supply lines VL0 to VLn, a plurality of ground lines GNL0 to GNLn, a plurality of first signal lines Sa0 to San, and a plurality of second signal lines Sb0 to Sbn, each extending in the longitudinal direction X along a row of the strain gages G0 to Gn.

The power supply lines VL0 to VLn are located on one end side of the strain gages G0 to Gn. The power supply lines VL0 to VLn each include one end connected to one end of a respective one of the strain gages G0 to Gn and the other end located on the proximal end side of the sheet base material 22, and extend approximately parallel to each other.

The first signal lines Sa0 to San are located between one end side of the strain gages G0 to Gn and the power supply lines VL0 to VLn. The first signal lines Sa0 to San each include one end connected to one end of a respective one of the strain gages G0 to Gn and the other end located on the proximal end side of the sheet base material 22, and extend approximately parallel to each other. The power supply lines VL0 to VLn and the first signal lines Sa0 to San are located within the area of the width W2 of the sheet base material 22.

The ground lines GNL0 to GNLn are located on the other end side of the strain gages G0 to Gn. The ground lines GNL0 to GNLn each include one end connected to the other end of a respective one of the strain gages G0 to Gn and the other end located on the proximal end side of the sheet base material 22, and extend approximately parallel to each other.

The second signal lines Sb0 to Sbn are located between the other end side of the strain gages G0 to Gn and the ground lines GNL0 to GNLn. The second signal lines Sb0 to Sbn each include one end connected to the other end of a respective one of the strain gages G0 to Gn and the other end located on the proximal end side of the sheet base material 22, and extend approximately parallel to each other. The ground lines GNL0 to GNLn are located within the area of the width W2 of the sheet base material 22.

The plurality of dummy wiring patterns E0 to En are provided to overlap an area of the sensor sheet 20 where the strain gages G0 to Gn, the power supply lines VL0 to VLn, the ground lines GNL0 to GNLn, the first signal lines Sa0 to San and the second signal lines Sb0 to Sbn are not provided. For example, each of the dummy wiring patterns E0 to En includes one or more dummy wiring lines formed straight.

In detail, the dummy wiring pattern E0 includes, for example, eight dummy wiring lines e1 to e8. Of the eight dummy wiring lines e1 to e8, four dummy wiring lines e1 to e4 are disposed on an area on one side of the strain gage G0 in the width direction Y. The four dummy wiring lines e1 to e4 each extend in the longitudinal direction X and are arranged to be spaced apart from and parallel with each other in the width direction Y. The four dummy wiring lines e1 to e4 are disposed within the width W2 and each has a length (height) approximately the same as that of the waveform lines C1 to C4 of the strain gage G0. The dummy wiring lines e1 and e3 are aligned with the power supply line VL0 and the first signal line Sa0, respectively, in the longitudinal direction X.

The other four dummy wiring lines e5 to e8 are arranged in an area on the other side of the strain gage G0 in the width direction Y. The four dummy wiring lines e5 to e8 each extend in the longitudinal direction X and are arranged to be spaced apart and parallel with respect to each other in the width direction Y. The four dummy wiring lines e5 to e8 are arranged within the width W2. and each has a length (height) approximately the same as that of the waveform lines C1 to C4 of the strain gage G0. The dummy wiring lines e6 and e8 are aligned with the second signal line Sb0 and the ground line GNL1, respectively, in the longitudinal direction X.

The dummy wiring pattern E1 includes, for example, four dummy wiring lines e1 to e4. The dummy wiring line e1 is located in the area between the power supply line VL0 and the first signal line Sa0 and extends in the longitudinal direction X from near the base line of the strain gage G0 to near the base line of the strain gage G1. The dummy wiring line e2 is disposed in the area between the dummy pattern D0, the strain gage G1 and the first signal line Sa0, and extends in the longitudinal direction X from near the base line of the strain gage G0 to near the base line of the strain gage G1. The dummy wiring lines e1 and e2 are aligned with the power supply line VL1 and the first signal line Sal, respectively, in the longitudinal direction X, and are further aligned with the dummy wiring lines e2 and e4 of the dummy wiring pattern E0, respectively, in the longitudinal direction X.

The dummy wiring line e3 of the dummy wiring pattern E1 is disposed in the area between the dummy pattern D0, the strain gage G1 and the second signal line Sb0, and extends in the longitudinal direction X from near the base line of the strain gage G0 to near the base line of the strain gage G1. The dummy wiring line e4 is disposed in the area between the ground line GNL0 and the second signal line Sb0 and extends in the longitudinal direction X from near the base line of the strain gage G0 to near the base line of the strain gage G1. The dummy wiring lines e3 and e4 are aligned with the second signal line Sb1 and the ground line GNL1, respectively, in the longitudinal direction X, and are further aligned with the dummy wiring lines e5 and e7 of the dummy wiring pattern E0, respectively, in the longitudinal direction X.

In the third embodiment, the other structures of the strain gage sensor device are similar to those of the strain gage sensor device in the first embodiment described above. According to the third embodiment configured as described above, the dummy patterns D0 to Dn are provided in the area between each respective pair of strain gages adjacent to each other. With this configuration, the modulus of elasticity of the area where the strain gages G0 to Gn are provided and that of the gap area where no strain gages are provided can be made substantially equal to each other in the sensor sheet 20. Further, with regard to the dummy wiring patterns E0 to En, they are provided in the area where the strain gages G0 to Gn, the power supply lines, the ground lines, and the signal lines are not provided. With this configuration, the elastic modulus of the area where the wiring lines are provided and the elastic modulus of the area where no wiring is provided can be made substantially equal to each other in the sensor sheet 20. With this configuration, it is possible to make the elastic modulus of the sensor sheet 20 more uniform in substantially the entire sensor sheet 20 in the longitudinal direction X.

As described above, in the third embodiment as well, it is possible to obtain a strain gage sensor device with improved detection accuracy.

Note that in the third embodiment, the dummy patterns D0 to Dn are not limited to the dummy patterns described in the embodiment, but the dummy patterns D0 to Dn illustrated in the first to third modified examples provided above may as well be used.

Furthermore, the dummy wiring patterns E0 to En described in the third embodiment can be applied to the sensor sheet described in the second embodiment provided above.

### Fourth Embodiment

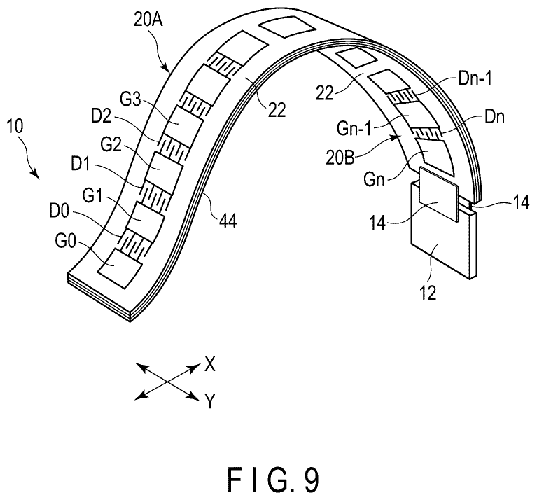

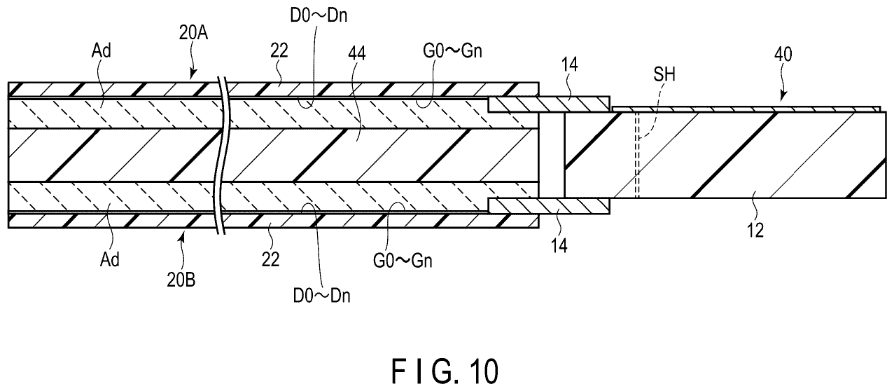

FIG. 9 is a perspective view showing a strain gage sensor device according to the fourth embodiment, and FIG. 10 is a cross-sectional view of the strain gage sensor device.

As shown in FIG. 9, the strain gage sensor device 10 of the fourth embodiment is configured as a double-sided strain gage sensor. The strain gage sensor device 10 comprises an elongated strip-shaped flexible base substrate 44, a first sensor sheet 20A attached to a first main surface (front surface) of the base substrate 44, a second sensor sheet 20B attached to s second main surface (rear surface) of the base substrate 44, and a relay substrate (drive circuit board) 12 connected to the first sensor sheet 20A and the second sensor sheet 20B via a flexible circuit board (FPC) 14. For example, the base substrate 44 is formed of a resin such as polyethylene terephthalate (PET), polyimide or the like, to have a thickness of about 0.3 to 0.5 mm.

Each of the first sensor sheet 20A and the second sensor sheet 20B includes an elongated strip-shaped flexible sheet base material 22 and a conductor pattern provided on one surface side of the sheet base material 22. The conductor pattern includes a plurality of strain gauges G0 to Gn and a plurality of dummy patterns D0 to Dn. The plurality of strain gauges G1 to Gn are arranged side by side in the longitudinal direction X at predetermined intervals therebetween from one end of the sheet base material 22 in the longitudinal direction X to the other end in the longitudinal direction X. As will be described later, the conductor patterns of the first sensor sheet 20A and the second sensor sheet 20B are formed, for example, to be similar to those of the first modified example described above.

FIG. 10 is a longitudinal cross-sectional view of the strain gauge sensor device 10 according to the fourth embodiment.

As shown in FIG. 10, the base substrate 44 includes a front surface and a rear surface opposing the front surface. For example, the first sensor sheet 20A includes a surface with conductor patterns (G1 to Gn, D0 to Dn), which is attached to the front surface of the base substrate 44 by an adhesive layer Ad such as a transparent adhesive sheet (OCA). The second sensor sheet 20B includes a surface with conductor patterns (G1 to Gn, D0 to Dn), which is attached to the rear surface of the base substrate 44 by an adhesive layer Ad.

The relay substrate 12 includes a drive circuit 40 and a plurality of wiring lines, provided on one surface side thereof and a plurality of wiring lines provided on the other surface side, which are not shown. The strain gages and the wiring lines not shown on the first sensor sheet 20A are connected to the wiring lines provided on an upper surface side of the relay substrate 12 via the FPC 14. Similarly, the strain gages and wiring lines not shown on the second sensor sheet 20B are connected to the wiring lines provided on a lower surface side of the relay substrate 12 via the FPC 14.

Some of the wiring lines of the first sensor sheet 20A and the second sensor sheet 20B may be connected to each other by connection wiring lines provided on the relay substrate 12, for example, by a plated-through hole SH. Note that the first sensor sheet 20A and the second sensor sheet 20B may as well be configured as such that the side of the sheet base material 22 is attached to the front surface and the rear surface of the base substrate 44 by means of the adhesive layer Ad.

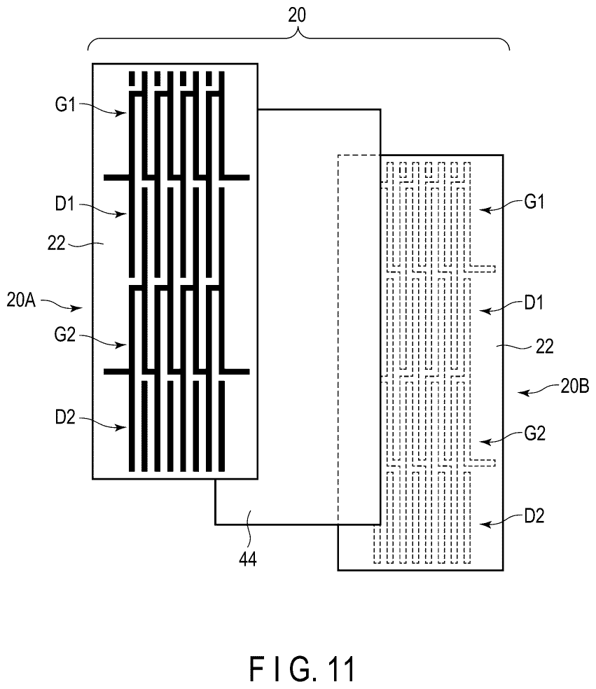

FIG. 11 is an exploded perspective view showing the first and second sensor sheets and a part of the base substrate. As shown in the figure, the first sensor sheet 20A includes a sheet base material 22 and a conductor pattern provided on the sheet base material 22. For example, the conductor pattern is formed in a manner similar to that of the conductor pattern shown in the first modified example, and includes strain gauges G0 to Gn, dummy patterns D0 to Dn, and a wiring pattern not shown. The second sensor sheet 20B is constituted in a manner similar to that of the first sensor sheet 20A, and includes similar conductor patterns (G0 to Gn, D0 to Dn, and wiring pattern). The conductor pattern of the second sensor sheet 20B is formed into a pattern that is inverted by 180 degrees in the XY direction relative to the conductor pattern of the first sensor sheet 20A. The second sensor sheet 20B is set to oppose the first sensor sheet 20A in an orientation rotated by 180 degrees in the Z direction relative to the first sensor sheet 20A. That is, as shown in FIG. 11, the rear surfaces of the first sensor sheet 20A and the second sensor sheet 20B oppose each other, but when viewed from the first sensor sheet 20A side, the pattern of the first sensor sheet 20A coincides with that of the second sensor sheet.

The first sensor sheet 20A and the second sensor sheet 20B configured as described above are attached to the front surface and rear surface of the base substrate 44 and oppose each other while interposing the base substrate 44 therebetween. That is, the strain gages G0 to Gn, dummy patterns D0 to Dn, and wiring lines of the first sensor sheet 20A oppose the strain gages G0 to Gn, dummy patterns D0 to Dn, and wiring lines of the second sensor sheet 20B, respectively, while interposing the base substrate 44 therebetween. Here, it is preferable that the strain gauges G0 to Gn, the dummy patterns D0 to Dn, and the wiring lines of the first sensor sheet and the strain gauges G0 to Gn, the dummy patterns D0 to Dn, and the wiring lines of the second sensor sheet should at least partially overlap each other in a plan view viewed from a direction perpendicular to the surface of the base substrate 44. Alternatively, the strain gauges G0 to Gn, the dummy patterns D0 to Dn, and the wiring lines of the sensor sheets 20A and 20B should preferably overlap each other at least without being displaced in the width direction Y while allowing displacement in the longitudinal direction X. Further, alternatively, the strain gauges G0 to Gn, the dummy patterns D0 to Dn, and the wiring lines of the sensor sheets 20A and 20B should preferably overlap each other without being displaced in the longitudinal direction X or in the width direction Y.

In the double-sided strain gage sensor device 10 of the fourth embodiment configured as described above, advantageous effects similar to those of the strain gage sensor device of the first embodiment described above can be obtained. That is, in the fourth embodiment as well, during strain detection, the strain gages of the sensor sheet can be curved uniformly along the circumferential surface of the sample and adhered to the outer circumferential surface. As a result, it is possible to obtain a strain gage sensor device with each strain gage, which can accurately detect the strain on the outer circumferential surface, thereby improving the detection accuracy.

Note that in the fourth embodiment, the configuration of each sensor sheet is not limited to that of the illustrated examples, and the sensor sheets described in the above-provided first, second, third, second and third embodiments may as well be applied.

While certain embodiments and variations have been described, these embodiments and variations have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

All configurations that can be implemented by a person skilled in the art based on each of the above-described configurations as embodiments of the invention, with appropriate design changes, are also within the scope of the invention, as long as they encompass the gist of the invention.

For example, the number of strain gauges arranged on the sensor sheet is not limited to those of the above-described embodiments, but can be selected arbitrarily. The materials, dimensions, and shape which constitute the sensor sheet are not limited to those of the above-described embodiments, but can be changed as needed.

What is claimed is:

1. A strain detection device comprising:
a sheet base material;
a plurality of strain gauges arranged in a first direction and provided on the sheet base material;
a plurality of power supply lines and a plurality of first signal lines each connected to a first end of a respective one of the plurality of strain gauges, and a plurality of ground lines and a plurality of second signal lines each connected to a second end of a respective one of the plurality of strain gauges; and
a dummy pattern provided on the sheet base material and located between two of the plurality of strain gauges, the two being adjacent to each other in the first direction.

2. The strain detection device of claim 1, wherein
the dummy pattern includes a plurality of dummy lines each extending in the first direction and arranged in a second direction intersecting the first direction.

3. The strain detection device of claim 2, wherein
the plurality of strain gauges are arranged to be spaced apart from each other in the first direction,
each of the strain gauges includes a base line extending in the second direction and a plurality of waveform lines each having a protruding part protruding from the base line toward a first side of the base line in the first direction, and
the plurality of dummy lines are arranged approximately in alignment with the plurality of waveform lines of the strain gages.

4. The strain detection device of claim 3, wherein
the plurality of dummy lines include a plurality of first lines connecting to a plurality of waveform lines of one of an adjacent pair of the strain gauges and a plurality of second lines connected to a plurality of waveform lines of an other one of the strain gauges, and
the plurality of first lines and the plurality of second lines are arranged alternately in the second direction.

5. The strain detection device of claim 4, wherein
at least one of the plurality of first lines and at least one of the plurality of second lines are divided into a plurality of portions in the first direction, and at least one of the portions faces one of the first lines or one of the second lines in the second direction.

6. The strain detection device of claim 5, wherein
each of the strain gauges includes a plurality of second waveform lines each having a second protruding part protruding from the base line toward a second side of the base line in the first direction, the second side being opposite to the first side, and
the dummy lines include a wavy dummy line extending in the second direction continuously in a wave-like manner.

7. The strain detection device of claim 1, further comprising a second dummy pattern on the sheet base material,
wherein the second dummy pattern is disposed in an area where the plurality of strain gauges, the plurality of dummy patterns, the plurality of power supply lines, the ground lines, and the first and second signal lines are not provided.

8. The strain detection device of claim 7, wherein
the second dummy pattern is disposed between each respective pair of the strain gages adjacent to each other in the first direction, and further comprises a plurality of second dummy lines provided between one of the respective pair of the strain gages and one of the first signal line, and between the one of the respective pair of the strain gages and a respective one of the ground lines.

9. A strain detection device comprising:
a sheet base material;
a plurality of strain gauges arranged in a first direction and provided on the sheet base material; and
a plurality of power supply lines and a plurality of first signal lines each connected to a first end of the plurality of strain gauges, and a plurality of ground lines and a plurality of second signal lines each connected to a second end of the plurality of strain gauges,
each of the strain gauges including a base line, a plurality of first waveform lines each having a first protruding part protruding from the base line toward a first side of the base line in the first direction, and a plurality of second waveform lines each having a second protruding part protruding from the base line toward a second side of the base line in the first direction, the second side being opposite to the first side,
the strain gages includes a first strain gage and a second strain gage that is adjacent the first strain gage in the first direction, and
a respective one of the first waveform lines of the first strain gage and a respective one of the second waveform lines of the second strain gage are arranged in the second direction.

10. The strain detection device of claim 9, further comprising a dummy wiring pattern on the sheet base material,
wherein the second dummy pattern is disposed in an area where the plurality of strain gauges, the plurality of dummy patterns, the plurality of power supply lines, the ground lines, and the first and second signal lines are not provided.

11. The strain detection device of claim 10, wherein
the dummy wiring pattern is disposed between each respective pair of the strain gages adjacent to each other in the first direction, and further comprises a plurality of dummy wiring lines provided between one of the respective pair of the strain gages and one of the first signal line, and between the one of the respective pair of the strain gages and a respective one of the ground lines.
